(19) United States
(12) Patent Application Publication
(10) Pub. No.: US 2013/0241127 A1
(43) Pub. Date: Sep. 19, 2013

(54) Food Processor for Processing and Cleaning Foods Easily and Quickly

(71) Applicant: Heng-De Yang, Tainan City (TW)

(72) Inventor: Heng-De Yang, Tainan City (TW)

(21) Appl. No.: 13/419,480

(22) Filed: Mar. 14, 2012

(51) Int. Cl. A47J 47/20

(52) U.S. Cl. 269/15

(57) ABSTRACT

A food processor includes a container having an interior provided with a receiving space, a straining basket removably mounted in the receiving space of the container, at least one chopping board removably mounted in the receiving space of the container, and two support bars retractably mounted on the container. Thus, the foods are processed by the chopping board, the wasted foods and water are pushed into and placed in the container, and the processed foods are pushed into and washed in the straining basket.

### BACKGROUND OF THE INVENTION

1. Field of the Invention

The present invention relates to a processor and, more particularly, to a food processor for processing foods, such as vegetables, fishes, meats and the like.

2. Description of the Related Art

A conventional chopping board 1 in accordance with the prior art shown in FIGS. 1 and 2 is placed on a sink 2 to treat foods, such as vegetables 3, fishes 4, meats and the like. However, both of the processed foods and the wasted materials are placed on the chopping board 1 after treatment of the foods so that the processed foods and the wasted materials are mixed easily, thereby causing a sanitary problem, and thereby causing inconvenience to the user.

A conventional food processor 5 in accordance with the prior art shown in FIGS. 3 and 4 comprises placement basket 50 and a chopping board 51 retractably mounted on the placement basket 50. The placement basket 50 has two handles 53 formed on two opposite ends thereof. The chopping board 51 has a bottom provided with a locking piece 52. When the chopping board 51 is retracted onto the placement basket 50, the locking piece 52 of the chopping board 51 is releasably locked onto one of the two handles 53 the placement basket 50, so that the chopping board 51 is locked onto the placement basket 50 temporarily. After the locking piece 52 of the chopping board 51 is detached from one of the two handles 53 the placement basket 50, the chopping board 51 is unlocked from the placement basket 50 and can be pulled outward relative to the placement basket 50 to expand the food processor 5 so that the food processor 5 can be placed on a sink 54. Thus, the chopping board 51 is used to process foods, such as vegetables, fishes, meats and the like. Then, the processed foods on the chopping board 51 after treatment of the foods are pushed into and placed in the placement basket 50. However, the wasted materials and water from the chopping board 51 easily fall down or flow into a compartment 55 of the sink 54, thereby dirtying the sink 54, and thereby causing inconvenience to the user when cleaning the sink 54.

### BRIEF SUMMARY OF THE INVENTION

In accordance with the present invention, there is provided a food processor, comprising a container having an interior provided with a receiving space, a straining basket removably mounted in the receiving space of the container, at least one chopping board removably mounted in the receiving space of the container, and two support bars retractably mounted on the container.

The container has two opposite ends each spaced from the chopping board and the straining basket. The chopping board has two opposite ends, with a gap being defined between each of the two opposite ends of the chopping board and a respective one of the two opposite ends of the container. The straining basket has two opposite ends, with a clearance being defined between each of the two opposite ends of the straining basket and a respective one of the two opposite ends of the container.

The receiving space of the container has two opposite sides each provided with a stop shoulder abutting the chopping board to support the chopping board. The chopping board has two opposite sides each abutting a top of the stop shoulder of the container. The receiving space of the container has a periphery wall provided with a plurality of positioning bosses pressing the chopping board to position the chopping board in the receiving space of the container. Each of the two opposite sides of the chopping board is pressed and positioned by the positioning bosses of the container.

The container has two guide tracks formed on two opposite sides thereof for mounting the support bars. Each of the support bars is inserted between the two guide tracks of the container. Each of the two support bars has a substantially U-shaped profile. The two support bars are retractably mounted on the two opposite ends of the container.

Each of the two opposite ends of the container has a protruding top provided with a hanging hole. The straining basket has two opposite sides each abutting a side of the stop shoulder of the container. The positioning bosses of the container are disposed above the stop shoulder. The chopping board is located above the straining basket and the stop shoulder of the container. The straining basket has a surface provided with a plurality of straining holes connected to the receiving space of the container. The container has a bottom provided with a draining hole connected to the receiving space, and the food processor further comprises a plug removably mounted in the draining hole of the container to block the draining hole of the container.

Preferably, the food processor comprises two chopping boards removably mounted in the receiving space of the container. The two chopping boards are juxtaposed to each other.

The primary objective of the present invention is to provide a food processor for processing and cleaning foods easily and quickly.

According to the primary advantage of the present invention, the foods are processed by the chopping board, the wasted foods and water are pushed into and placed in the container, and the processed foods are pushed into and washed in the straining basket, so that the food processor can process, wash and clean the foods quickly and completely, thereby facilitating a user processing and washing the foods.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIGS. 1 and 2 show a conventional chopping board in accordance with the prior art.

FIG. 3 is an exploded perspective view of a conventional food processor in accordance with the prior art.

FIG. 4 is a front assembly view of the conventional food processor as shown in FIG. 3.

FIG. 5 is a perspective view of a food processor in accordance with the preferred embodiment of the present invention.

FIG. 6 is an exploded perspective view of the food processor as shown in FIG. 5.

FIG. 7 is a side cross-sectional view of the food processor as shown in FIG. 5.

FIG. 8 is a schematic operational view of the food processor as shown in FIG. 5 in use.

FIG. 9 is a schematic operational view of the food processor as shown in FIG. 5 in use.

FIG. 10 is an exploded perspective view of a food processor in accordance with another preferred embodiment of the present invention.

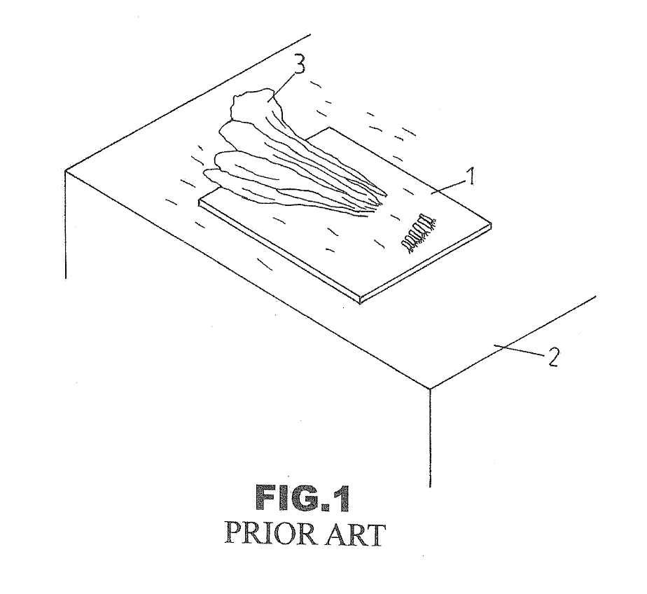

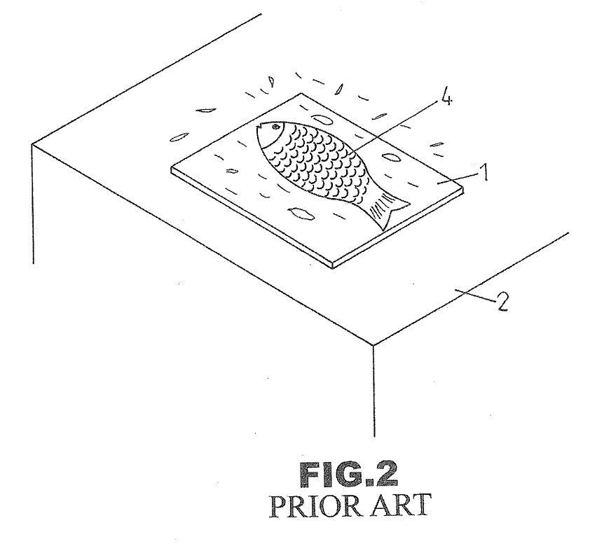

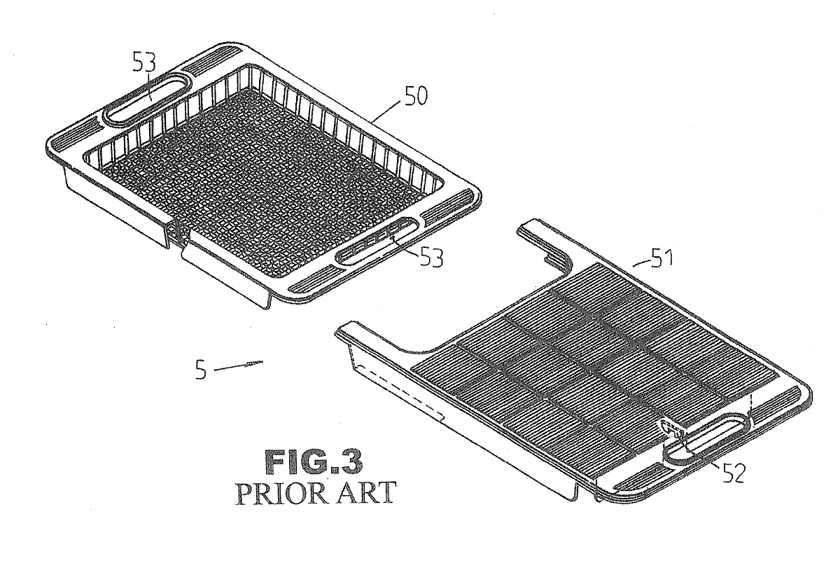

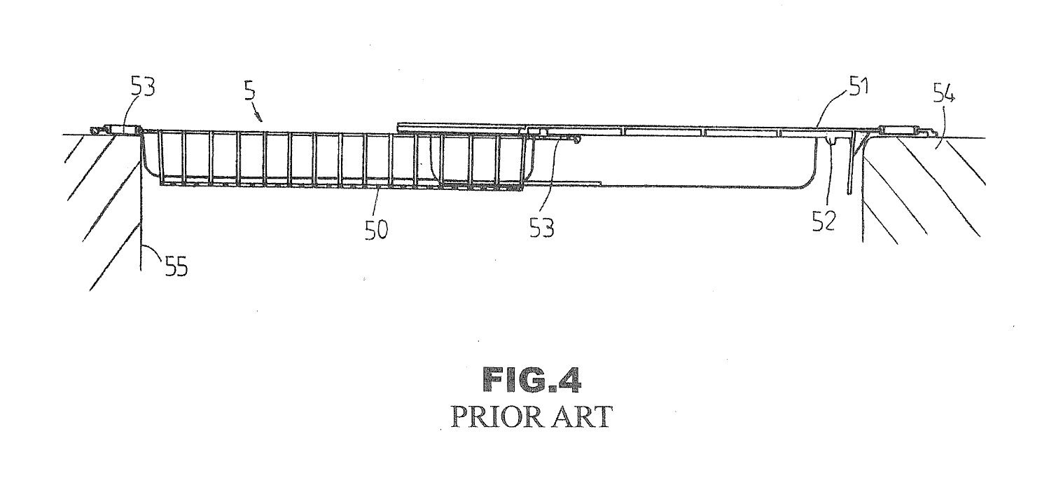

### DETAILED DESCRIPTION OF THE INVENTION

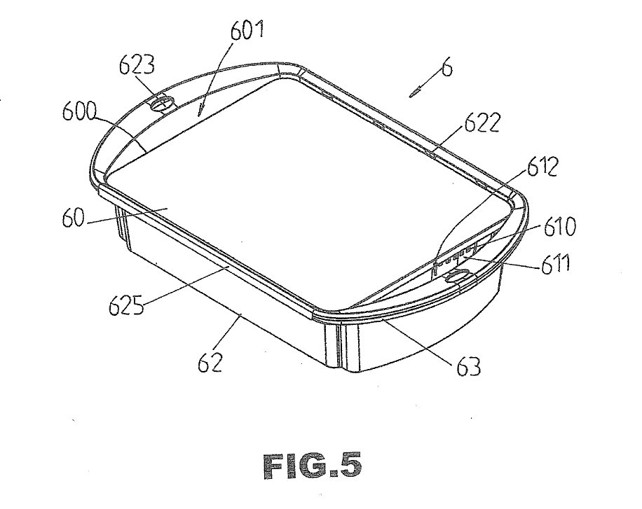

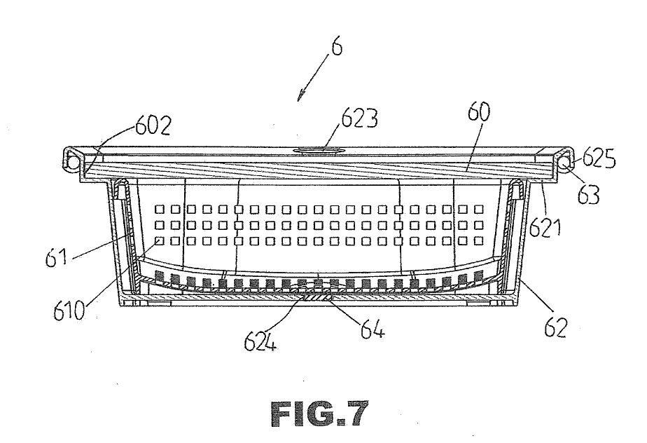

Referring to the drawings and initially to FIGS. 5-7, a food processor 6 in accordance with the preferred embodiment of the present invention comprises a container 62 having an interior provided with a receiving space 620, a straining basket 61 removably mounted in the receiving space 620 of the container 62, at least one chopping board 60 removably mounted in the receiving space 620 of the container 62, and two support bars 63 retractably mounted on the container 62.

The container 62 has a bottom provided with a draining hole 624 connected to the receiving space 620, and a plug 64 is removably mounted in the draining hole 624 of the container 62 to block the draining hole 624 of the container 62. The container 62 has two guide tracks 625 formed on two opposite sides thereof for mounting the support bars 63. The container 62 has two opposite ends 626 each spaced from the chopping board 60 and the straining basket 61. Each of the two opposite ends 626 of the container 62 has a protruding top provided with a hanging hole 623. The receiving space 620 of the container 62 has two opposite sides each provided with a stop shoulder 621 abutting the chopping board 60 to support the chopping board 60. The receiving space 620 of the container 62 has a periphery wall provided with a plurality of positioning bosses 622 pressing the chopping board 60 to position the chopping board 60 in the receiving space 620 of the container 62. The positioning bosses 622 of the container 62 are disposed above the stop shoulder 621.

The chopping board 60 is located above the straining basket 61 and the stop shoulder 621 of the container 62. The chopping board 60 has two opposite sides 602 each abutting a top of the stop shoulder 621 of the container 62. Each of the two opposite sides 602 of the chopping board 60 is pressed and positioned by the positioning bosses 622 of the container 62. The chopping board 60 has two opposite ends 600, with a gap 601 being defined between each of the two opposite ends 600 of the chopping board 60 and a respective one of the two opposite ends 626 of the container 62. The chopping board 60 has two opposite surfaces with two different colors to facilitate a user processing cooked and uncooked foods.

The straining basket 61 has a surface provided with a plurality of straining holes 610 connected to the receiving space 620 of the container 62. The straining basket 61 has two opposite sides each abutting a side of the stop shoulder 621 of the container 62. The straining basket 61 has two opposite ends 611, with a clearance 612 being defined between each of the two opposite ends 611 of the straining basket 61 and a respective one of the two opposite ends 626 of the container 62.

The two support bars 63 are retractably mounted on the two opposite ends 626 of the container 62. Each of the two support bars 63 has a substantially U-shaped profile. Each of the support bars 63 is inserted between the two guide tracks 625 of the container 62.

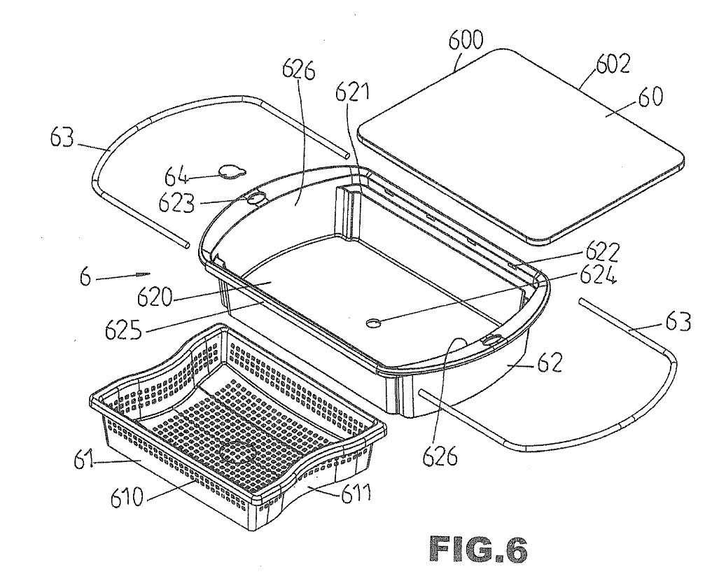

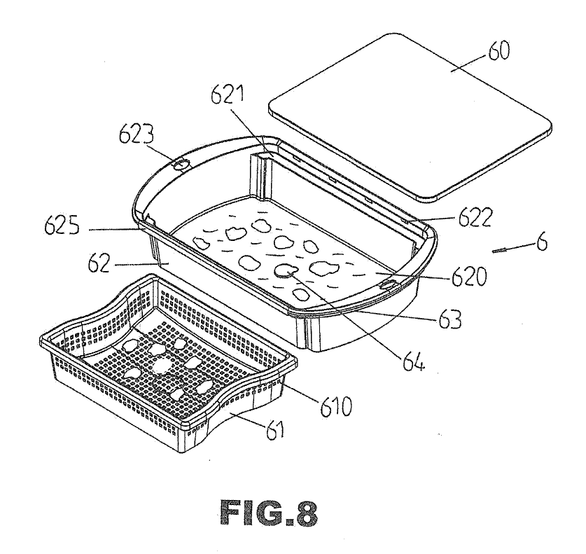

In operation, referring to FIG. 8 with reference to FIGS. 5-7, the support bars 63 are retracted into the two guide tracks 625 of the container 62, and the straining basket 61 and the chopping board 60 are mounted in the receiving space 620 of the container 62 as shown in FIGS. 5 and 6. In such a manner, the chopping board 60 is used to process foods, such as vegetables, fishes, meats and the like. At this time, wasted foods and water from the chopping board 60 are pushed into and placed in the container 62. Then, the chopping board 60 is removed from the receiving space 620 of the container 62, and processed foods on the chopping board 60 are pushed into and placed in the straining basket 61. Then, the straining basket 61 is directly placed on a sink for washing the processed foods. Thus, the food processor 6 can process, wash and clean the foods completely.

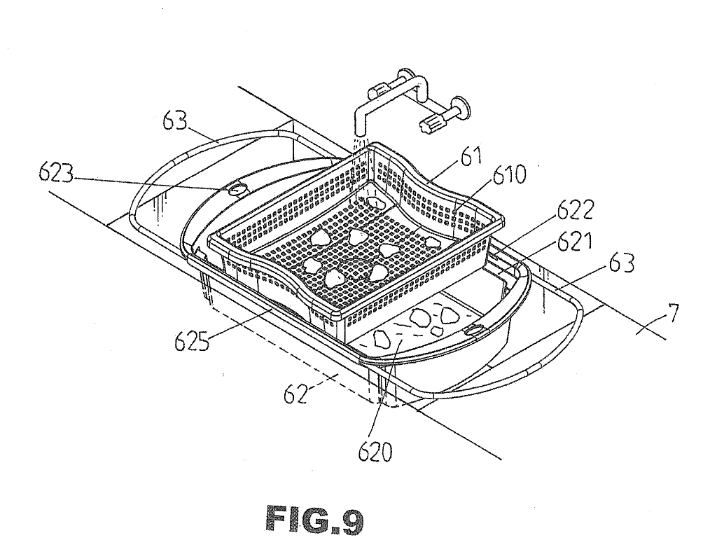

Alternatively, referring to FIG. 9 with reference to FIGS. 5-7, the support bars 63 are pulled and extended outward from the two guide tracks 625 of the container 62 and are placed on a sink 7 so that the container 62 are mounted on and supported by the sink 7. At this time, the straining basket 61 and the chopping board 60 are mounted in the receiving space 620 of the container 62. In such a manner, the chopping board 60 is used to process foods, such as vegetables, fishes, meats and the like. At this time, wasted foods and water from the chopping board 60 are pushed into and placed in the container 62. Then, the chopping board 60 is removed from the receiving space 620 of the container 62, and processed foods on the chopping board 60 are pushed into and placed in the straining basket 61. Then, the straining basket 61 is removed from the receiving space 620 of the container 62. Then, the plug 64 is removed from the draining hole 624 of the container 62. Then, the straining basket 61 is again placed in the container 62 as shown in FIG. 9. In such a manner, the processed foods in the straining basket 61 can be washed and cleaned on the sink 7. At this time, water strained from the straining holes 610 of the straining basket 61 is drained from the draining hole 624 of the container 62 into the sink 7. Thus, the food processor 6 can process, wash and clean the foods completely.

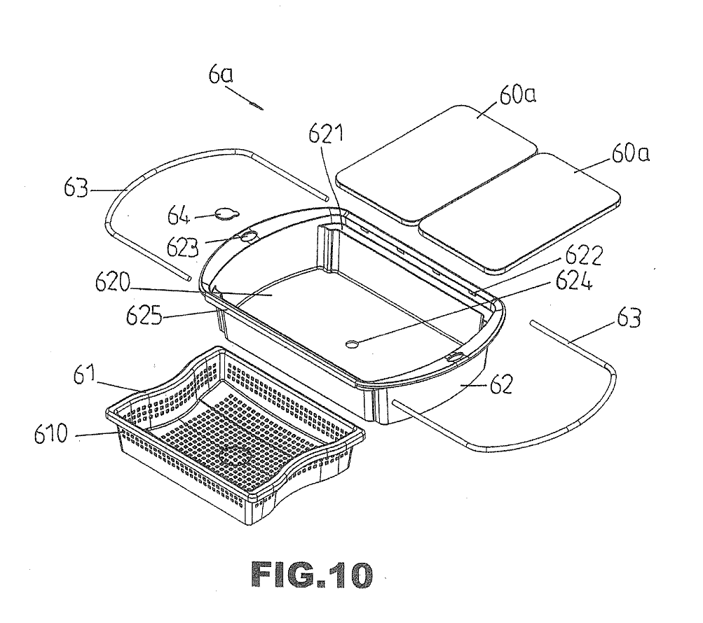

As shown in FIG. 10, the food processor 6a in accordance with another preferred embodiment of the present invention comprises two chopping boards 60a removably mounted in the receiving space 620 of the container 62. The two chopping boards 60a are juxtaposed to each other. Each of the two chopping boards 60a has two opposite surfaces with two different colors to facilitate a user processing foods of different kinds.

Accordingly, the foods are processed by the chopping board 60, the wasted foods and water are pushed into and placed in the container 62, and the processed foods are pushed into and washed in the straining basket 61, so that the food processor 6 can process, wash and clean the foods quickly and completely, thereby facilitating a user processing and washing the foods.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A food processor, comprising:
a container having an interior provided with a receiving space;
a straining basket removably mounted in the receiving space of the container;
at least one chopping board removably mounted in the receiving space of the container; and
two support bars retractably mounted on the container.

2. The food processor of claim 1, wherein the container has two opposite ends each spaced from the chopping board and the straining basket.

3. The food processor of claim 2, wherein the chopping board has two opposite ends, with a gap being defined between each of the two opposite ends of the chopping board and a respective one of the two opposite ends of the container.

4. The food processor of claim 2, wherein the straining basket has two opposite ends, with a clearance being defined between each of the two opposite ends of the straining basket and a respective one of the two opposite ends of the container.

5. The food processor of claim 1, wherein
the receiving space of the container has two opposite sides each provided with a stop shoulder abutting the chopping board to support the chopping board; and
the chopping board has two opposite sides each abutting a top of the stop shoulder of the container.

6. The food processor of claim 5, wherein
the receiving space of the container has a periphery wall provided with a plurality of positioning bosses pressing the chopping board to position the chopping board in the receiving space of the container; and
each of the two opposite sides of the chopping board is pressed and positioned by the positioning bosses of the container.

7. The food processor of claim 1, wherein
the container has two guide tracks formed on two opposite sides thereof for mounting the support bars;
each of the support bars is inserted between the two guide tracks of the container.

8. The food processor of claim 7, wherein each of the two support bars has a substantially U-shaped profile.

9. The food processor of claim 2, wherein the two support bars are retractably mounted on the two opposite ends of the container.

10. The food processor of claim 2, wherein each of the two opposite ends of the container has a protruding top provided with a hanging hole.

11. The food processor of claim 5, wherein the straining basket has two opposite sides each abutting a side of the stop shoulder of the container.

12. The food processor of claim 6, wherein the positioning bosses of the container are disposed above the stop shoulder.

13. The food processor of claim 5, wherein the chopping board is located above the straining basket and the stop shoulder of the container.

14. The food processor of claim 1, wherein the straining basket has a surface provided with a plurality of straining holes connected to the receiving space of the container.

15. The food processor of claim 1, wherein
the container has a bottom provided with a draining hole connected to the receiving space; and
the food processor further comprises a plug removably mounted in the draining hole of the container to block the draining hole of the container.

16. The food processor of claim 1, wherein the food processor comprises two chopping boards removably mounted in the receiving space of the container.

17. The food processor of claim 16, wherein the two chopping boards are juxtaposed to each other.
